(19) United States
(12) Patent Application Publication
(10) Pub. No.: US 2018/0233742 A1
(43) Pub. Date: Aug. 16, 2018

(54) ELECTROCATALYSIS OF LITHIUM POLYSULFIDES: CURRENT COLLECTORS AS ELECTRODES IN LI/S BATTERY CONFIGURATION

(71) Applicant: Wayne State University, Detroit, MI (US)

(72) Inventors: Mohana Leela Reddy Arava, Farmington Hils, MI (US); Ganguli Babu, Detroit, MI (US); K.Y. Simon Ng, West Bloomfield, MI (US); Khalid Ababtain, Dearborn, MI (US)

(21) Appl. No.: 15/516,437

(22) PCT Filed: Oct. 7, 2015
(86) PCT No.: PCT/US15/54397

§ 371 Date: Apr. 3, 2017

Related U.S. Application Data
(60) Provisional application No. 62/061,515, filed on Oct. 8, 2014.

(51) Int. Cl. H01M 4/38; H01M 4/66; H01M 4/90; H01M 4/36

(52) U.S. Cl. CPC H01M 4/382; H01M 4/661; H01M 4/366; H01M 4/667; H01M 4/9041; H01M 4/663

(57) ABSTRACT

This disclosure describes a new method and device that lead to improved performance (in the areas of energy density, power density, and cycle life) of any sulfur or selenide based including their respective polysulfide/polyselenides battery configurations both for stationary and portable applications. A device capable of converting lower polysulfides/polyselenides to higher polysulfides/polyselenides (and vice versa) and trapping said compounds in a highly porous matrix is described. The device may be rechargeable. Catalytically-active materials such as bulk metal structures, thin films of metals, microporous/nanoporous structures of materials, and carbon composites of metals and their alloys can be used as current collectors, electrodes, or both.

### BACKGROUND

### 1. Technical Field

The present disclosure relates to power storage and battery devices. More particularly, the present disclosure relates to materials capable of utilizing lithium/sulfur chemistries to form a catalytically or electrocatalytically-active material as current collectors, as electrodes, or both or electrocatalytically-active material contain composites with any form of carbon and/or polymers.

### 2. Background Information

Lithium-sulfur (Li/S) chemistries are amongst the most promising next-generation battery technologies due to their high theoretical energy density. However, the detrimental effects of polysulfides (PS), byproducts of electrochemical process, formed during the sequential intermediate reaction process have to be resolved to realize these theoretical performance limits. Recent research efforts in Li/S batteries have focused on entrapping these dissolved polysulfides using carbon structures to overcome the detrimental effects they have on battery performance, such efforts have yielded limited success.

In this application, a deviation from the prevalent approach by introducing catalysis in Li/S battery configuration rather than focusing on electrochemical byproducts is disclosed. Engineered current collectors themselves were found to be catalytically active towards lithium polysulfides, thereby eliminating the need for carbon structures coating their surface. By introducing catalysis into Li/S batteries in this way, substantial enhancement in electrochemical performance and corroborate the findings using a detailed experimental parametric study involving variation of several kinetic parameters such as surface area, temperature, current rates and concentration of polysulfides.

The past decade has witnessed a renewed interest in development of high energy storage devices, the interest is further bolstered by their potential applications for plug-in hybrid and electric vehicles. Intercalation materials employed in conventional Li-ion batteries impose limitations on the energy density limits that can be achieved. These shortcomings have stimulated research in alternative battery chemistries. Rechargeable lithium/sulfur (Li/S) batteries have gained attraction due to their high theoretical capacity of 1675 mAh g⁻¹ of sulfur cathode, wide range of temperature operation and low cost. In spite of several research efforts on this subject, key issues related to “redox shuttle reactions” between sulfur cathode and Li anode have not been fully addressed yet. Poor understanding and lack of control on the series of intermediate lithium polysulfides (PS) are commonly identified problems in all Li/S battery configurations such as solid, liquid and flow cells. Though the overall redox reaction is primarily driven by the dissolution of lithium polysulfides into the electrolyte, the insulating nature of the polysulfides and its predisposition to corrode the lithium anode results in low charging efficiency, short cycle life and high self-discharges.

The ubiquitous growth in portability of both handheld electronics as well as electric vehicles has largely been fueled by the progress made in electrochemical energy storage. Li-ion batteries have been at the forefront of this energy storage transformation, however, if the future energy needs are taken into account the current pace of technological progress will be unable to sustain the demand. Beyond the limitations of Li-ion batteries, Lithium-sulfur (Li—S) system is a promising electrochemical energy storage technology due to its low cost, high theoretical energy density, safety, and eco-friendliness. However, practical applications of the Li—S battery is hindered by a multitude of issues like short cycle life, poor coulombic efficiency, poisoning of Li-anode, self-discharge etc. The underlying primary reason behind these performance barriers is the well-known polysulfide-shuttle mechanism, a process initiated in the preliminary stages of battery discharging. This mechanism results in dissolution of PS into the electrolyte solution causing undesirable mass transport of electroactive species resulting in the formation a passivation layer on Li-anode. Insulating nature of sulfur and its end products of discharge (Li₂S₂ and Li₂S) further lead to slow charge/discharge process and increase in cell polarization. Barchasz et al., and others reported that passivation of cathode surface by insoluble byproducts and poor adsorption of soluble PS are primary reason for poor performance of Li—S battery.

Substantially increasing the contact area between active sulfur and the conductive matrix can retain power density and cycle life of the device in the face of insulating nature of dissolved polysulfides it is necessary to substantially increase the contact of active sulfur with the conductive matrix. Though several carbonaceous materials modified at the nanoscale are extensively used as electronic conductors, problems of processing nano/micro porous carbons, binders and achieving high sulfur loading have not yet been thoroughly addressed. In spite of some success on effective sulfur loading in some of porous carbon structures, the intrinsic issues of pore clogging due to deposition of lower order polysulfides (Li₂S₂ and Li₂S) remains to be addressed.

Deposition of such solid insulating blocks on electrochemically active surfaces increases internal resistances resulting in substantial raise in overpotential and capacity fade upon extended cycling of the cell. Recent research reports have bypassed the sulfur loading step by incorporating intermediate polysulfides (catholyte) in the electrolyte itself.

Irrespective of the nature of the starting cathode, i.e. either C—S composite or liquid catholyte, it is recognized that Li/S battery configuration eventually morphs itself into a liquid electrochemical cell due to the formation of intermediate polysulfides at the very beginning of the discharge step. Hence, understanding and controlling kinetics of redox reactions of polysulfides plays a role in commercializing Li/S battery technology.

The insulating nature of polysulfides causes poor reaction kinetics and hence influences overall redox process. Several prior research efforts on enhancing reaction kinetics of polysulfides are limited to aqueous polysulfide systems. Use of electrocatalytic electrodes has been found to enhance the performance of photoelectrochemical solar cells and aqueous red-ox flow cells. However, there have been no reports on utilizing electrocatalysis concepts in non-aqueous polysulfides redox reactions. This application describes investigations on an electrocatalyst effect on Li-polysulfide redox reactions and developed a novel Li/S battery configurations without use of any carbon matrix. Different electrocatalysts such as platinum (Pt), gold (Au) and nickel (Ni) have been coated on aluminum (Al) and stainless steel (SS) foils and serve the dual role of current collector and electrode for Li/S battery configurations. Engineered porous SS and Ni foils have been found to act as efficient current collectors and electrodes there by resulting novel battery configuration called “Metal-PS-Metal” battery.

### BRIEF SUMMARY OF THE INVENTION

To be completed after claims are finalized

### BRIEF DESCRIPTION OF THE DRAWINGS

FIG. 1 is a schematic representation of lithium polysulfide conversion on an electrocatalyst surface or current collector in accordance with one embodiment of the present disclosure;

FIG. 2A is a graphical representation of charge/discharge plateaus of a device in accordance with one embodiment of the present disclosure;

FIG. 2B is a graphical representation of cycling behaviors of devices in accordance with one embodiment of the present disclosure;

FIG. 3A is a cyclic voltammogram (CV) derived with a device of the present disclosure;

FIG. 3B is a graphical representation of X-Ray Diffraction (XRD) patterns of thermally evaporated nickel films 50 nm and 200 nm thick on aluminum substrates derived from a device of the present disclosure;

FIG. 3C is a graphical representation of cycling behaviors of devices in accordance with one embodiment of the present disclosure;

FIG. 3D is a graphical representation of rate capability behaviors of devices in accordance with one embodiment of the present disclosure;

FIG. 4A is a graphical representation of electrocatalyst activities of devices in accordance with one embodiment of the present disclosure;

FIG. 4B is a graphical representation of temperature effects on charge/discharge polarization of devices in accordance with one embodiment of the present disclosure;

FIGS. 5A and 5B are scanning electron micrographs of surfaces of devices in accordance with one embodiment of the present disclosure;

FIG. 5C is a comparison of discharge capacity values exhibited by different devices in accordance with an embodiment of the invention of the present disclosure;

FIG. 6A-6B are comparative CV curves of conventional carbon electrode and nickel electrocatalyst at different scan rates towards lithium polysulfide conversions vs. Li/Li+;

FIG. 7A-7B are charge-discharge profiles of different nickel surfaces toward lithium polysulfide conversions vs. Li/Li+ in the potential window 1.5 to 3.0 V;

FIG. 8 is a schematic illustration of electrocatalyst-anchored graphene nanocomposite preparation and its interaction with polysulfide during the charge/discharge process of a Li—S battery;

FIG. 9A-B are field emission scanning electron microscopy (FESEM) images of nanocomposites in accordance with the present disclosure;

FIG. 9C-D are energy-dispersive X-ray spectroscopy (EDX) analyses of the nanocomposites of FIG. 9A-B;

FIG. 10 is powder XRD patterns recorded for graphene and metal/graphene composites;

FIG. 11A-B are graphical representations of electrical performance measures of devices of the present disclosure;

FIG. 12A-B are graphical representations of catalytic measures of devices of the present disclosure;

FIG. 13A-B are electrochemical impedance spectra of graphene and Pt/graphene electrodes;

FIG. 14A-D are graphical representations of various properties of Pt/graphene electrodes in accordance with the principles of the present invention;

FIG. 15 is an XRD pattern confirming formation of a Pt—S peak at a discharged state and its reversibility in a charged state; and

FIG. 16A-G are measures of platinum/polysulfide interactions in a device according to the principles of the present disclosure.

### DETAILED DESCRIPTION OF THE DRAWINGS AND THE PRESENTLY PREFERRED EMBODIMENTS

As used herein with regard to a range, the term “between” is inclusive of the endpoints of said range, unless it is clear that the endpoints are excluded. For example, when “an integer between 1 and 3” is recited, the integer may have a value of 1, or of 2, or of 3.

As used herein, the terms “substantially” and “about” mean “approximately but not necessarily equal to,” and when used in the context of a numerical value or range set forth means a variation of ±20%, or less, of the numerical value. For example, a value differing by ±20%, ±15%, ±10%, or ±5%, or any value in the range between −20% and +20%, would satisfy the definition of “substantially” or “about.”

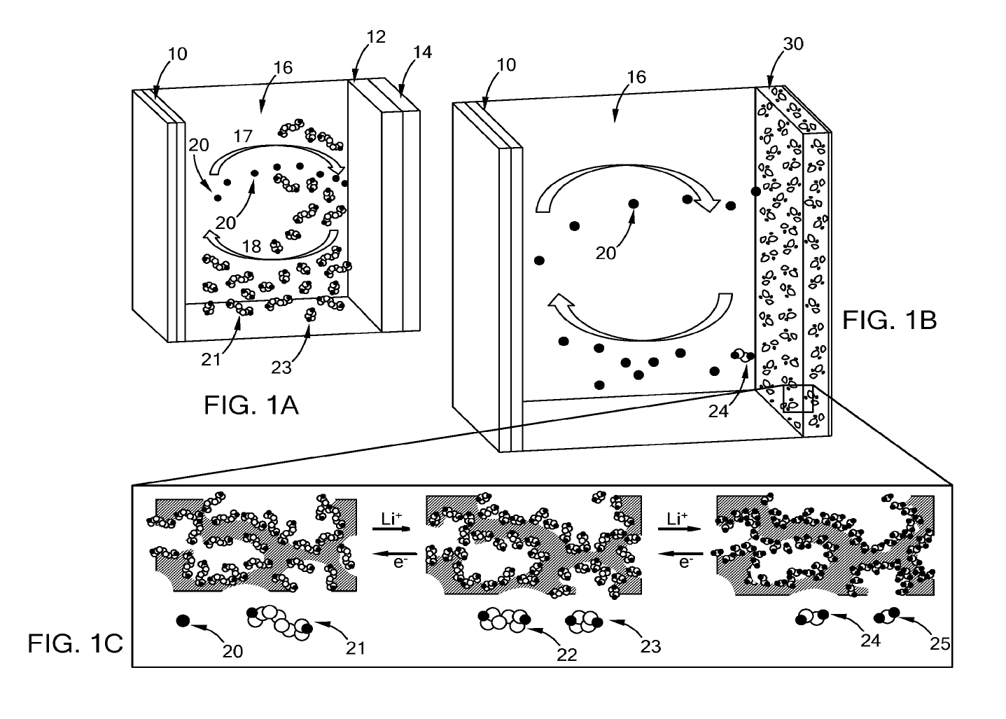

FIG. 1A illustrates a prior art lithium-sulfur battery. The battery includes lithium anode 10, carbon cathode 12, and metal current collector 14. Electrolyte solution 16 sits between the two poles. The chemistry of the cell is illustrated schematically by representing lithium atoms as black circles and sulfur atoms as white circles. Free lithium ions 20 flow from anode 10 toward cathode 12 (see arrow 17) and lithium/sulfur compounds, particular polysulfides such as Li₂S₈ (21) and Li₂S₄ (23) flow toward the anode (in direction 18). The shuttling of polysulfide compounds reduces the efficiency of a battery having a conventional configuration, as the polysulfides (which have a net negative charge) bind to the lithium anode (which, being metallic, attracts the negative charges) and in doing so give rise to an insulating effect.

FIG. 1B, on the other hand, is a battery configuration in accordance with the principles of the present invention. The battery of FIG. 1B includes lithium anode 10 and combination cathode and three-dimensional current collector 30. The current collector 30 in this embodiment lacks the carbon cathode and instead substitutes a metallic surface upon which lithium-sulfur compounds can bind and undergo electrocatalysis. Without wishing to be bound by a particular theory, a schematic showing a potential mode of operation of the battery is shown in FIG. 1B, with a minimum of polysulfide species remaining being in solution or bound anywhere other than the electrocatalyst/current collector 30.

FIG. 1C is a close-up view of the current collector 30. The current collector 30 is of a porous construction, increasing the surface area of the current collector 30. The increased surface area allows for binding of greater quantities of lithium/sulfur compounds. A sample electrocatalytic reaction scheme is illustrated in FIG. 1C. In the rightmost panel, Li₂S (25) and Li₂S₂ (24) are bound to the current collector 30. The addition of electrons drives conversion to Li₂S₄ (23) and Li₂S₆ (22), and further electrons to Li₂S₈ (21) and lithium ions (20).

As will be described in the figures that follow, the current collector and/or cathode of a battery, and having the formula XₐY_{b}Z_{c}. In this formula, X is a first metal, Y is a second metal, and Z is selected from the group consisting of oxygen (O), carbon (C), nitrogen (N), and sulfur (S). In this formula, a is an integer from 1 to 3 inclusive; b is an integer from 0 to 3 inclusive; and c is an integer from 0 to 7 inclusive. X and Y may be selected from the group consisting of Ni, Pt, Pd, Co, Fe, Cr, Ti, Mn, Zn, Cu, Pb, Cd, Mo, In, Sn, W, Bi, Rh, Ag, Nb, Au, and Zr. In cases where the current collector is a metal and not an oxide, a carbide, a sulfide, or a nitride, c=0. In cases where a single metal species is present, b=0.

Battery performance is enhanced when catalytically active materials such as those listed above, when used as current collectors and/or electrodes, are combined with metal and alloy-based anodes, such as those made from at least one of Li, K, Ca, Mg, Na, Al, Mn, Zn, and so forth. A corresponding metal-based polysulfide- or polyselenide-containing electrolyte is also employed and increases battery performance, where the species in the electrolyte can be of the formula J_{d}Lₑ, in which J is selected from the group consisting of Li, K, Ca, Mg, Na, Al, Mn, Zn, and so forth; L is selected from the group consisting of S and Se; d is an integer from 1 to 4 inclusive; and e is an integer from 1 to 12 inclusive. In one embodiment, the metal or metals of the electrolyte are the same as those chosen for the anode. Such electrocatalysis-assisted polysulfide/polyselenide conversion process is excellent for battery performance.

Use of electrocatalytically active metals serves a dual purpose of providing a current collector as well as an electrode for polysulfide conversion on the cathode side. This results in a new battery configurations of M1/M1Q_{g}/M2, wherein M1 can be lithium, potassium, calcium, sodium, magnesium, aluminum, manganese, zinc, and a combination or hybrid thereof, in some embodiments with other materials; M1 Q_{g} is the corresponding polysulfide or polyselenide of M1, wherein Q represents S, Se, or both, and g is an integer from 1 to 9; and M2 is any electrocatalytically-active material such is listed above, in some instances taking the form of XₐY_{b}Z_{c}. Thus, a portable rechargeable battery or stationary flow battery based on polysulfide shuttling phenomena can be built using catalytically active current collectors and cathodes.

To understand the effect of electrocatalyst on polysulfides red-ox reaction and hence overall electrochemical properties of this novel concept of using current collectors itself as carbon free electrodes for Li—S battery configuration, different traditional electocatalysts such as Pt, Au and Ni and non-electrolcatalyst Al (for controlled experiments) are described. These metals are separately coated (about 50 nanometers (nm)) on two different substrates such as Al and stainless steel (SS) foil and used them as working electrodes to fabricate standard 2032 type coin cells.

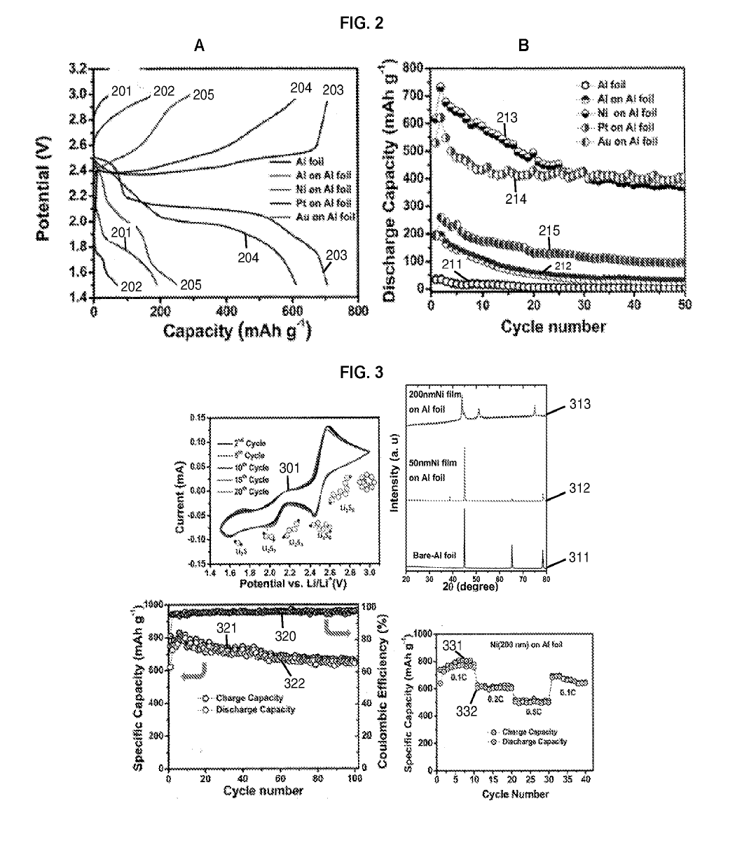

Coin cell fabrication is performed under inert atmosphere (Ar filled glove box) using Li metal anode and catholyte (10 μl) as an active material and quartz membrane as a separator. Galvanostatic measurements conducted at a constant current rate of 0.1 C (based on sulfur mass in the cell) and obtained results have been monitored for 50 cycles of charge/discharge. As shown in FIGS. 2A and 2B, the electrocatalyst plays a role in polysulfide conversion. Though Al electrodes were found to be inactive for polysulfides conversion (plot 201, Al foil; plot 202, Al on Al foil) due to their ultra-low capacity and large polarization of charge-discharge profiles, other electrodes (demonstrated on Al foil: Pt 204, Au 205, and Ni 203) show enhanced performance with well-defined plateaus of charge-discharge around 2.4 and 2.0 V respectively, which is similar to a conventional carbon electrode (FIG. 2A).

Among different electrocatalyst studied, Ni and Pt electrodes exhibit comparable discharge capacities of about 370 and about 395 mAh/g, respectively, at the end of the 50^{th} cycle (Table 1).

TABLE 1
Properties of Electrocatalysts

| | Type of Electrocatalyst | | | |
|---|---|---|---|---|
| Electrochemical properties | Pt | Ni | Au | Al |
| Discharge capacity at 50^{th} cycle | 395 | 370 | 95 | 25 |
| (mAh g⁻¹) | | | | |
| Discharge plateau (V) | 2.01 | 2.11 | 1.99 | 1.85 |
| Polarization difference at 50% of | 0.52 | 0.31 | 0.64 | 1.22 |
| DOD (V) | | | | |

With its inherent electrochemical activity, the Pt electrode exhibits good cycle life over 50 charge-discharge cycles but shows larger polarization in charge-discharge curves compared to Ni electrode (FIG. 2B, plots 214 and 213 respectively). Plots of Al foil (211), Al on Al foil (212), and Au on Al foil (215) are also shown. However, despite its great promise as an electrocatalyst for polysulfide conversion process, thermally evaporated Ni films of 50 nm thickness were found to be partially oxidised due to their high sensitivity towards open atmosphere.

Surface oxidation issues of 50 nm thick Ni films were resolved by increasing the thickness of the film to 200 nm. XRD patterns of thermally evaporated nickel films of 50 nm (312) and 200 nm (313) on an aluminum substrate are shown in FIG. 3B and compared with bare aluminum foil (311).

Electrochemical potential and corresponding current were monitored as a function of cycle number. FIG. 3A shows that representative cyclic voltammetry (CV) of Ni electrode vs. Li/Li+ at a scan rate of 0.5 mV s⁻¹ with 10 microliters (μl) of Li₂S₈ in tetraethylene glycol dimethylether (TEGDME) solvent containing 1 molar (M) lithium bis-trifluoromethylenesufonimide (LiTFSI) and 0.1M lithium nitrate (LiNO₃) as catholyte. Recorded CV curves, curves shown on the 2^{nd}, 5^{th}, 10^{th}, 15^{th}, and 20^{th} cycles, overlapping on curve 301, consist of two reduction peaks at 2.44 and 1.9 V corresponding to conversion of elemental sulfur to higher polysulfides (Li₂S₈) and subsequent disproportion in electrolyte and further reduction to lower lithium polysulfides respectively. Upon oxidation, two corresponding peaks at 2.52 and 2.57 V relates to conversion of lower lithium polysulfides to higher polysulfides and formation of elemental sulfur (FIG. 3B). The constancy of redox peak currents upon increasing number of CV scans (FIG. 3A) indicates the overall stability or activity of electrocatalyst towards long cycling performance. Conversely, a conventional cell with carbon as working electrode shows significant reduction in peak currents upon cycling due to decrease in active sites on carbon electrode.

Further, CVs of Ni electrode were recorded at different scan rates ranging from 0.2 to 1.0 mV/s with an increment of 0.2 mV s⁻¹ in order to understand the kinetics of Ni electrocatalyst towards polysulfides conversions. Shift in the anodic and cathodic peaks of CV with increase in scan rate is a general trend in any carbon based Li—S battery configurations, which is considered as an evidence for quasi reversible reaction of polysulfides.

Conventional carbon electrode shows shift in the anodic/cathodic peaks towards positive/negative potentials respectively indicating quasi reversible process of polysulfides. Ni electrode showed almost stable peak position with increase of scan rate, thereby indicating its suitability towards higher current rates of charge/discharge process.

Cathodic and anodic peak potentials of conventional carbon electrode and Ni electrode are summarized along with exchange current density values in Table 2. The lower oxidation potential and higher reduction potentials are an indication of an efficient electrochemical system.

TABLE 2
CYCLIC VOLTAMMETRY-DERIVED
PARAMETERS OF LI-POLYSULFIDE SYSTEMS

| | E1ₚₐ, | | Exchange current |
|---|---|---|---|
| SYSTEM | E2ₚₐ (V) | E1_{pc}, E2_{pc} (V) | density (mA cm⁻²) |
| Conventional (carbon) | 2.79, — | 2.4, 1.84 | 0.049 |
| Present study (Ni | 2.53, 2.58 | 2.44, 1.90 | 0.071 |
| electrocatalyst) | | | |

Herein, the Ni electrode shows lower oxidation potentials of about 2.53 V and about 2.57 V compared to that of carbon electrode (2.79 V), further confirming the influence of electrocatalytic mechanism towards a polysulfide conversion process. Further, exchange current density values calculated from a tafel plot reveal that Ni electrode has better kinetics than that of carbon electrode. Therefore, a newly designed lithium polysulfide battery system containing electrocatalyst (Ni film) as electrode may result in superior charge/discharge characteristics due to its better reaction kinetics towards PS conversion process.

To evaluate specific capacity, cycleability, columbic efficiency and rate capabilities of a Ni electrode based Li—S battery, galvanostatic charge (plot 321)/discharge (plot 322) measurements were performed. The cycleability vs. specific capacity and columbic efficiency plots of 200 nm thick Ni electrode at 0.1 C rate are described in FIG. 3C. Ni film acting as both current collector and electrode delivered a steady state capacity up to 700 mAh g⁻¹ over 100 cycles of charge/discharge with an excellent columbic efficiency of <98% (plot 320).

To investigate its suitability for high power applications, rate capability tests were also performed on Ni electrocatalyst (FIG. 3D). A 200 nm thick Ni electrode based Li—S cell was first subjected to low C-rate of 0.1 C to obtain stable nominal capacity. Subsequent cycling was conducted at higher current rates of 0.2 and 0.5 C for each 10 cycles. At the end of the high C-rate (0.5 C) test, the cell was operated at 0.1 C rate in order to understand the capacity retention. Observed specific capacity values of 780, 605, and 510 mAh g⁻¹ at 0.1, 0.2 and 0.5 C rates respectively, support the electrocatalysis concept and suitability for high power applications. Charge measures are shown in plots 331, and discharge measures are shown in plots 332.

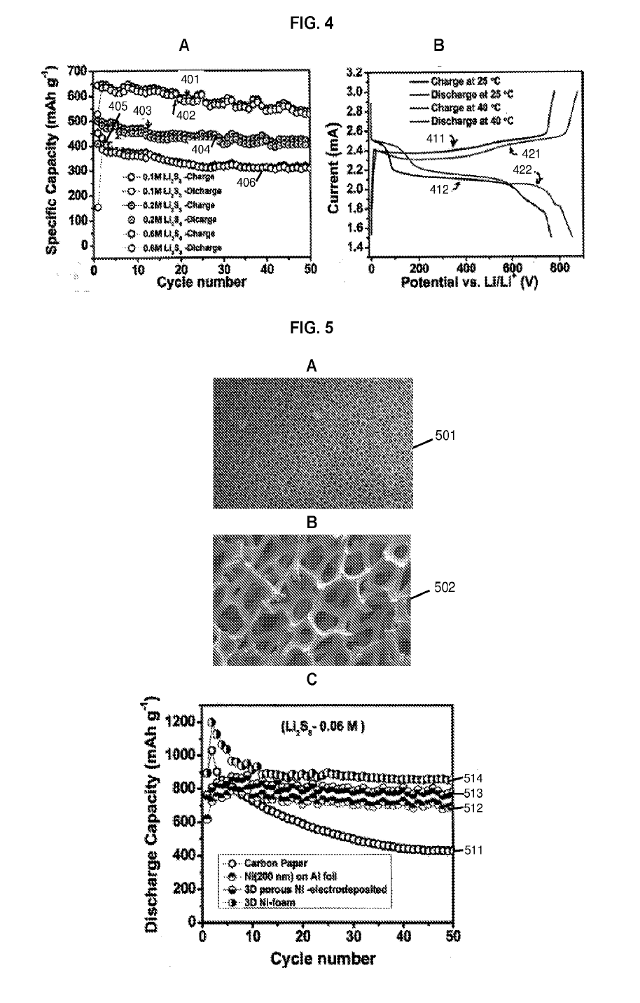

The energy density per unit area of Li—S cell can be increased by increasing the amount of sulfur content in catholyte. However, such an increase in sulfur loading can reduce electrochemical properties of the cell. In order to understand the effect of polysulfide concentration on electrochemical performance of electrocatalyst, different catholytes having 100, 200 and 600 mM concentration of Li₂S₈ were prepared and tested against Ni (200 nm film) electrode. Specific capacity vs. cyclic number shown in FIG. 4A was a result of galvanostatic charge/discharge measurements conducted on Ni electrodes against different concentrations (0.1 M, charge 401, discharge 402; 0.2 M, charge 403, discharge 404; 0.6 M, charge 405, discharge 406) of polysulfides. The decrease in overall specific capacity of the Li—S cell with increase in the concentration of polysulfides was due to increase in viscosity of the electrolyte. However, at any given concentration of the polysulfides, all cells showed cyclic stability over 50 cycles. Especially, cells with 100 mM and 200 mM concentrations of Li₂S₈ show the specific capacity of 650 and 500 mAh g⁻¹ respectively are evidence of extending the electrocatalysis concept to higher concentration of polysulfides.

Another property of an efficient electrocatalyst is its positive response towards temperatures. The kinetics of a catalytic process is expected to be enhanced with an increase in temperature. FIG. 4B reveals the effect of temperature on electrochemical performance of lithium-polysulfide battery whose capacity values were found to be enhanced by 10% when the cell is heated to 40° C. (charge 421, discharge 422) from room temperature (25° C., charge 411, discharge 412.) The polarization between the charge and discharge plateaus was found to be reduced with increase of cell temperature, which is most important and beneficial point in view of battery applications. The plateau region at 2.4 V associated to the conversion of elemental sulfur to Li₂S₈ was also found to be enhanced at 40° C. Such enhancement in plateau region may be related to efficient conversion efficiency of insoluble end products to elemental sulfur upon charging since the plateau may depend on available elemental sulfur.

Electrocatalytic activity of any electrocatalyst depends on its accessible surface area. Hence, an increase in the surface area of Ni electrocatalyst (electrode) should result in enhanced polysulfide conversion properties. Two different Ni structures with high surface area (micro porous 3D Ni prepared by electrodeposition at −10 mA cm⁻², 501, and commercially available 3D Ni foam, 502) were compared with regard to their electrocatalytic properties and with those of planar substrates.

FIGS. 5A and 5B are the SEM images of microporous 3D Ni 501 and Macroporous 3D Ni foam 502 respectively. FIG. 5C represents a comparison of the electrochemical properties of these two materials. Specific capacity values of Ni electrode were found to increase with increase in surface area. Microporous 3D Ni exhibits the discharge capacity of 800 mAh g⁻¹ for 50 cycles (plot 513), whereas macroporous 3D Ni foam shows further improvement to 900 mAh g⁻¹ with excellent capacity retention (plot 514). Carbon paper is shown as plot 511, and 200 nm layer of nickel on aluminum foil is shown as plot 512. It is noted that, in general, electrocatalysis surface accessibility is maximum with meso or macropore structure than that of micropore structures. Hence, the observed superior performance of macropore structured 3D Ni over microporous 3D Ni structures is in good agreement with traditional electrocatalysis process.

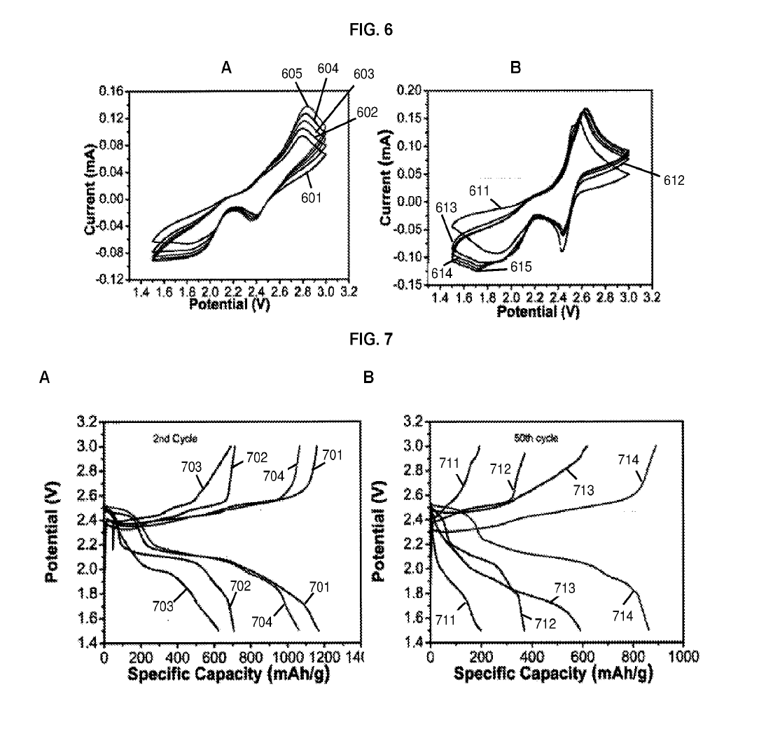

FIG. 6 illustrates CV curves of a conventional carbon electrode (FIG. 6A; plot 601 at a scan rate of 0.2 mV/s, plot 602 at 0.4 mV/s, plot 603 at 0.6 mV/s, plot 604 at 0.8 mV/s, and plot 605 at 1.0 mV/s) and a nickel electrocatalyst (FIG. 6B; plot 611 at a scan rate of 0.2 mV/s, plot 612 at 0.4 mV/s, plot 613 at 0.6 mV/s, plot 614 at 0.8 mV/s, and plot 615 at 1.0 mV/s) toward lithium polysulfide conversions versus Li/Li+.

FIG. 7 illustrates charge/discharge profiles of different Ni surfaces toward lithium polysulfide conversions versus Li/Li+ in the potential window 1.5V to 3.0V. FIG. 7A shows the second cycle measurement for carbon paper (plot 701), 50 nm nickel film (702), 3D nickel electrodeposited (703), and 3D nickel foam (704). FIG. 7B shows the fiftieth cycle measurement for carbon paper (plot 711), 50 nm nickel film (712), 3D nickel electrodeposited (713), and 3D nickel foam (714).

A carbon free Li—S battery configuration has been demonstrated using concept of electrocatalysis. Lithium polysulfide conversions reactions have been found to take place on electrocatalytic surfaces such as Pt, Au and Ni. Use of Ni in Li—S battery configuration has found to be two folded, acting as current collector and also electrode, thereby eliminating the traditional tedious process of synthesis and fabrication of highly porous micro/nano carbon structures. Detail electrochemical studies involving specific capacity, cyclic stability, rate capability and columbic efficiency as a function of polysulfides concentration, temperature and surface area of electrode/current collector revealed that Ni based electrodes were capable of delivering stable capacities up to 900 mAh g⁻¹. Thus, this novel concept of electrocatalysis of lithium polysulfides, a carbon free cathode, will open up a new avenue for developing most awaiting Li—S battery technology for both stationary and portable applications.

Recent research efforts have been directed towards designing polymer electrolytes that prevents the migration of PS and surface coatings on Li-anode to avoid PS passivation. In other hand, carbon materials for improving conductivity of sulfur and trapping intermediate polysulfides with the cathode of the cell. In search of finding carbon hosts for polysulfides, several micro/meso porous structures, carbon nanotubes, graphene etc., have been investigated thoroughly. The poor adsorption capabilities of carbons towards polar natured polysulfides have further triggered research interest in finding alternative host materials. Moreover, the PS conversion reaction kinetics worsens with prolonged cycling due to increase in internal resistance caused by deposition of insulating short-chain PS. In marked contrast to all the above mentioned approaches, the PS-shuttle process in Li—S cell can be controlled by means of electrocatalysis. Use of electrocatalytic current collectors such as Pt or Ni when coated on Al foil has shown to enhance both cycle life and reaction kinetics of the Li—S battery. Despite the fact that surface chemistry of metal thin films enhances the PS anchoring strength, active material loading is limited due to constrained surface area.

In order to effectively utilize catalysts (Pt and Ni) while ensuring high surface area to host polysulfides, the present study is aimed at understanding the structural and electrochemical properties of graphene supported nanocatalyst. The high surface area, superior mechanical and electrical properties, electrochemical compatibility and its prior attempts to host sulfur cathode, makes graphene as an ultimate choice for supporting electrocatalysts.

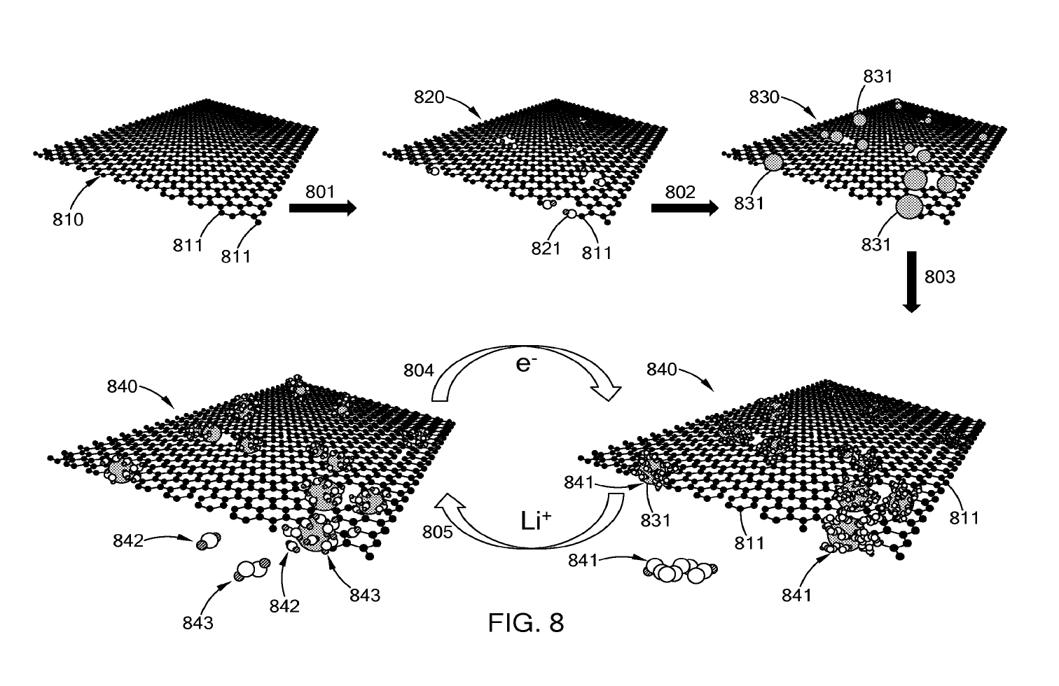

Step-by-step process of graphene nanocomposites preparation and their interaction with lithium polysulfides during charge/discharge process are illustrated schematically in FIG. 8. Graphene layer 810 is made of carbon atoms 811. In first step 801, the graphite layer is functionalized by the addition of functional groups 821 to form functionalized graphene layer 820. In second step 802, metal atoms 831 are bound at the sites of functionalization. In a third step 803, lithium polysulfide molecules 841 bind to the metal atoms 831. The charge 805/discharge 804 process showing the conversion of Li₂S₈ 841 to Li₂S 842, Li₂S₂ 843, and other species.

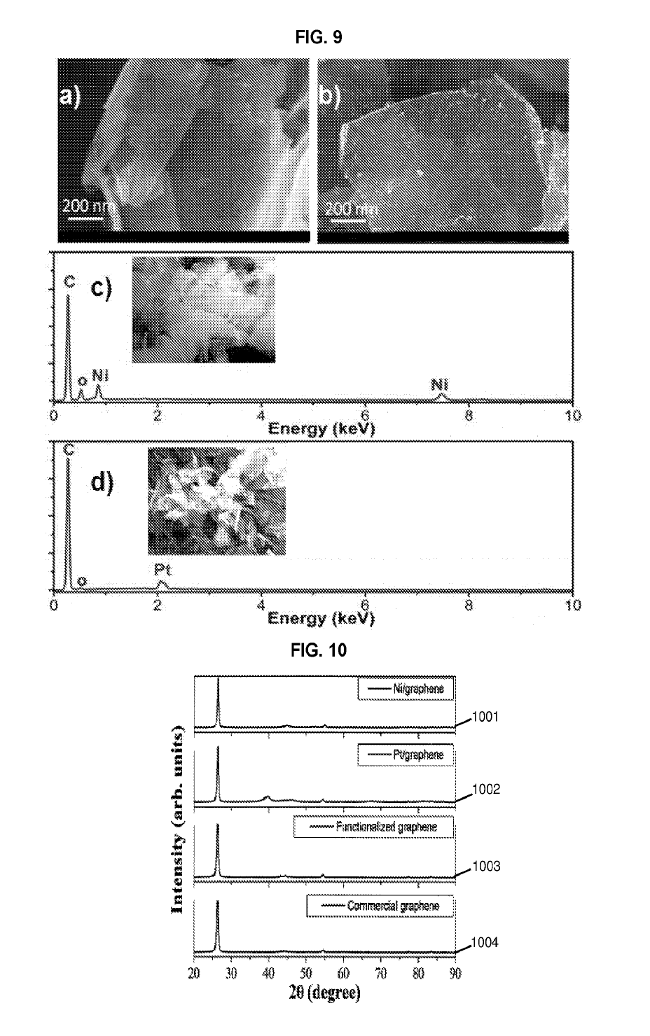

For the synthesis of such composites, firstly, chemical functionalization of few layer graphene was performed in reflux condenser using concentrated nitric acid at 120° C. under the Ar flow. Pt and Ni nanoparticles are dispersed uniformly on such functionalized graphene sheets to increase their surface anchoring strength. Field emission scanning electron spectroscopy (FESEM) images and elemental mapping of Ni/Graphene and Pt/Graphene are shown in FIG. 2a-d. Randomly oriented graphene sheets of few-microns in size and ripple-like flake morphology are depicted in FESEM images. In the case of Ni/Graphene and Pt/Graphene composites, a spatial distribution of metallic nanoparticles about 20 nm in size over the layered graphene sheets was observed (FIG. 9A, 9B). Further, energy dispersive X-ray spectroscopic (EDX) analysis confirmed the homogeneous distribution of respective elements with (FIG. 9C, 9D). From X-ray diffraction studies (XRD), it is determined that the interspacing distance between graphene layers is 3.34 Å and crystal structure of electrocatalyst is face-centered cubic (FIG. 10, plot 1001 representing Ni/graphene, 1002 Pt/graphene, 1003 functionalized graphene, 1004 commercial graphene).

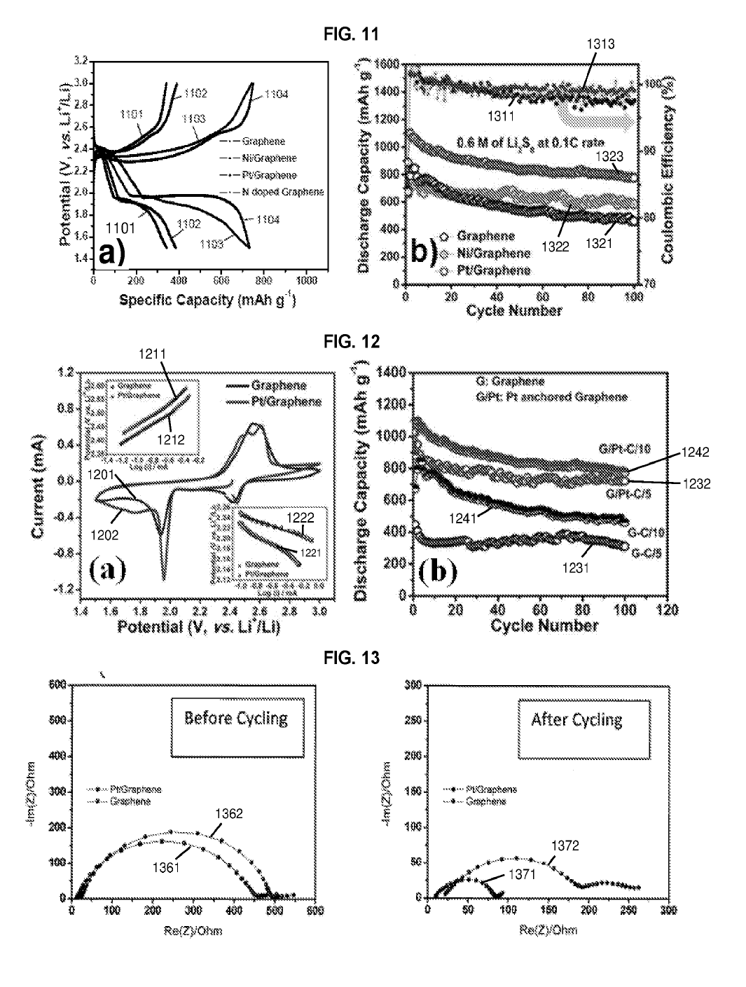

To evaluate the electrochemical performance of graphene and its nanocomposites, standard 2032 coin cells were fabricated using them as cathode vs metallic lithium as an anode and dissolved Li₂S₈ in electrolyte (catholyte) as an active material. For better comparison, parameters such as concentration and quantity of catholyte (0.6 M and 10 μl) during cell fabrication have been maintained constant. Galvanostatic charge-discharge studies were performed at a constant current rate of 0.1 C (based on sulfur mass in the cell) and obtained results for 100 cycles have been displayed in FIG. 11. From FIG. 11A, it has been observed that electrodes exhibited well defined discharge plateaus corresponding to the formation of soluble long-chain PS and their spontaneous dissociation into short-chain PS and vice-versa during charging process (graphene plot 1101, Ni/graphene plot 1102, Pt/graphene plot 1103.) A nitrogen-doped graphene functions similarly well to (plot 1104) or better than Pt/graphene with regard to charge/discharge and coulombic efficiency.

On careful observation, Pt/Graphene electrode shows two discharge plateaus at 2.4 and 1.97 V and a charging plateau at 2.34 V. Ni/Graphene and Pt/Graphene electrodes exhibit initial specific capacity of 740 and 1100 mAh g⁻¹ and retains a stable capacity of 580 and 789 mAh g⁻¹ after 100 cycles of charge/discharge. In comparison with pristine graphene, Ni/Graphene and Pt/Graphene resulted in 20% and 40% enhancement in capacity respectively. More notably, Pt/Graphene electrode showcases excellent stability in coulombic efficiency (˜99.3%) upon cycling (FIG. 11B, plot 1313). Thus Pt is promising as an electrocatalyst to convert short-chain to long-chain lithium polysulfides (LiPS) efficiently in kinetically facile manner during charging. The deposition of insulating PS on graphene impedes the electron transfer at electrode/electrolyte interface and results in an increase of internal resistance. In case of electrocatalyst anchored graphene, the presence of catalyst (Pt or Ni) helps to convert these PS deposits back to soluble long-chain polysulfides and hence enhances reaction kinetics and retains high coulombic efficiency. As Pt/Graphene is found to exhibit superior performance over Ni/Graphene and graphene (with a capacity at the 100^{th} cycle of 789 mAh/g, versus 580 mAh/g for Ni/Graphene and 460 mAh/g for graphene, these electrodes having a coulombic efficiency at the 100^{th} cycle of 99.0%, 98.2%, and 97.3% respectively), further studies have been focused on evaluating its electrocatalytic properties and its possible interactions with LIPS during cycling process.

In order to validate the electrocatalytic activity of Pt/Graphene over pristine graphene, cyclic voltammograms (CVs) have been recorded at a slow scan rate of 0.05 mV s⁻¹ (FIG. 12A, plot 1201 representing graphene, 1202 Pt/graphene). Similar to charge-discharge profiles, two characteristic reduction peaks (cathodic) were observed on CV corresponds to the disproportion of long-chain polysulfides and formation of Li₂S₂ and Li₂S respectively. On forward scan, broad oxidation peak at 2.57 V for pristine graphene is attributed to the conversion of short-chain to long-chain LiPS. However, the CV of Pt/Graphene is displays two distinguishable oxidation peaks evidence the better reversibility of reaction at given scan rate. When the CV of Pt/Graphene is compared to that of Graphene, the distinguishable positive shift in reduction peak and negative shift in oxidation peak indicates the superior catalytic activity of Pt containing electrode towards LiPS conversion process. These peak shifts typically indicate a decrease in cell polarization which is in good agreement with galvanostatic charge/discharge profiles shown in FIG. 11A. Further, Tafel plots and corresponding exchange current density values have been derived from potentiostatic polarization experiments to understand the effect of catalyst on charge transfer kinetics during charge and discharge reaction process (inset of FIG. 12A; charge of graphene is plot 1211, charge of Pt/graphene is plot 1212, discharge of graphene is plot 1221, discharge of Pt/graphene is plot 1222). The calculated exchange current densities (i₀) of pristine and Pt/Graphene electrodes are 1.18 and 3.18 mA cm⁻² for cathodic process and 0.17 and 0.29 mA cm⁻² for anodic process, respectively. Thus, the increase in exchange current density values of Pt/Graphene in both charge and discharge process confirms the enhancement in rate of LiPS conversion reactions. Further, electrochemical impedance spectra (EIS) have been recorded to envisage the electrocatalyst influence on charge transfer resistance. FIG. 13 shows the typical Nyquist plots measured before (FIG. 13A, Pt/graphene plot 1361, graphene plot 1362) and after (FIG. 13B, Pt/graphene plot 1371, graphene plot 1372) 10 charge-discharge cycles. An inferior electrode-electrolyte interface resistance for Pt/Graphene (60Ω) over pristine graphene electrode (170Ω) has been observed. Furthermore, EIS of pristine graphene exhibits an extra-flattened semicircle, which could be due to deposition of insoluble products on electrode surface. Hence, reduced redox peak separation, higher exchange current density and minimal electrode-electrolyte resistance are clearly in agreement with the claimed catalysis of PS in presence of Pt/Graphene electrode.

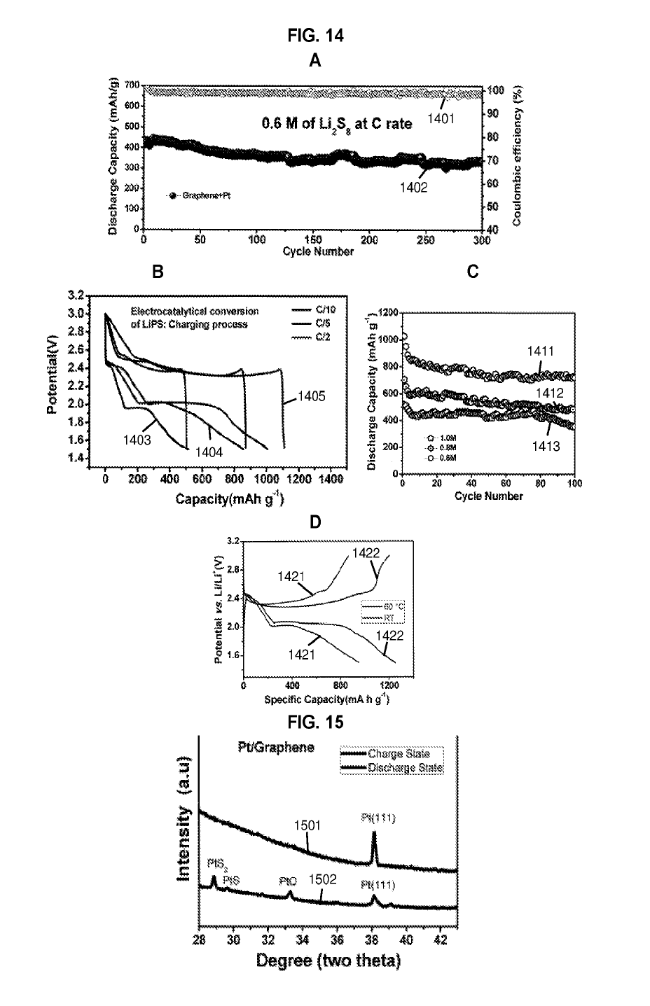

Electrochemical behaviour of Graphene and Pt/Graphene electrodes at different C-rates has been performed to reveal the surface anchoring strength of electrocatalyst towards PS conversions. As shown in FIG. 12B, Pt/Graphene electrode (plot 1232 and 1242) delivers superior specific capacity compared to that of pristine graphene electrode at both C/5 (plot 1231) and C/10 (plot 1241). For instance, the discharge capacity of 780 mAh g⁻¹ has been exhibited by Pt/Graphene electrode at 0.2 C for 100 cycles. This is almost double as that of graphene (380 mAh g⁻¹) under similar conditions. The Pt/Graphene electrode was further subjected to long cycling (about 300 cycles) at 1 C-rate and it exhibited a stable performance with minimal capacity loss of 0.09% per cycle (FIG. 14A, plot 1402, with coulombic efficiency percentage at 1401). Voltage vs capacity plot for the Pt/Graphene electrode shows typical discharge and charge plateaus at high current rates (FIG. 14B; C/2 as plot 1403, C/5 plot 1404, C/10 plot 1405). The charging plateau relies more on the electrochemical activity of cathode material which includes conversion of short-chain to long-chain LiPS. The consistency in charging plateaus, even with high C-rates suggests the enhanced reaction kinetics due to presence of electrocatalyst. To understand the feasibility of Pt/Graphene electrode towards high sulfur loading, higher molar concentration of catholyte containing 0.8M and 1.0M Li₂S₈ (corresponds to 1.61 and 2.0 mg of sulfur per cre respectively) have been prepared and subjected to electrochemical studies. As shown in FIG. 14C, Pt/Graphene electrode exhibits specific capacities of 550 and 410 mAh g⁻¹ with 0.8M (1412 plot) and 1.0 M (plot 1413) of Li₂S₈ respectively at 0.2 C-rate with stability over 100 cycles. 0.6 M compared at plot 1411.

In order to validate electrocatalyst sensitivity towards temperature, the cell containing Pt/Graphene electrode was first cycled at room temperature for 5 cycles and then cycled at 60° C. In agreement with electrocatalysis behavior, Pt/Graphene electrode showed significantly reduced polarization at 60° C. (plot 1422) compared to room temperature (plot 1421) with enhanced specific capacity (FIG. 14D).

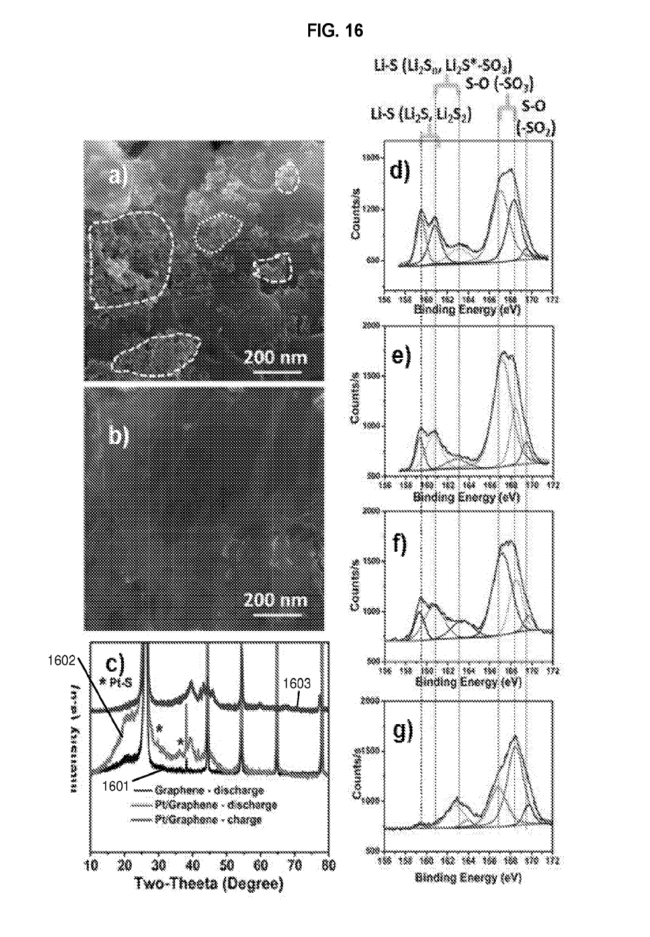

The interaction between electrocatalyst and polysulfides during charge and discharge process have been probed by conducting FESEM, XRD and X-ray photoelectron spectroscopy (XPS) studies on cycled cells. Electrodes are de-crimped carefully from 2032 coin cells, washed thoroughly with tetraethylene glycol dimethyl ether (TEGDME) solvent and dried in vacuum for 12 h. After five charge-discharge cycles, both Graphene and Pt/Graphene electrodes are examined in discharge and charged state separately. FESEM images of Graphene and Pt/Graphene electrodes at charged state are respectively shown in FIG. 16A and FIG. 16B. The presence of precipitated insoluble LIPS (marked with broken lines) in Graphene electrode and its significant reduction in Pt/Graphene further evident that catalyst helps to keep the electrode structure active even after several cycles of charge/discharge process (FIG. 15, charge plot 1501, discharge plot 1502). From XRD patterns, formation of platinum sulfide on the discharged state (20=29.2° and 36.4°) and further its fading up on charging (FIG. 16C & FIG. 15) has been observed. FIG. 16C illustrates a discharge plot of graphene 1601, a charge plot of Pt/graphene 1603, discharge of Pt/Graphene 1602. Hence, it is confirmed that nature of interactions between Pt and sulfur is reversible and accountable for stable electrochemical performance.

Further, XPS spectra for Graphene and Pt/Graphene electrodes at discharged and charged state have been recorded to understand Pt-polysulfide interactions. From FIG. 16D-FIG. 16G, XPS spectra of de-convoluted S₂ₚ peaks, peaks 159.3 eV corresponding to the formation of insoluble Li₂S and Li₂S₂ products observed in both discharge and charged states of Graphene electrode. The presence of such peaks in charged state indicates poor reversibility of deposited short-chain polysulfides to long-chain polysulfides. In other hand, significant reduction in the relative area of XPS peak is observed for the charged state of Pt/Graphene electrode witness the better reversibility. The positive shift in other two peaks of Pt (charged state) at 162.7 and 163.9 eV are ascribed to S—O and S—S band, especially later evidence the formation of elemental sulfur with respect to Pt/Graphene. Furthermore, from the de-convoluted 4f7/2 and 4f5/2 peaks of Pt, the presence of Pt²⁺ species indicates interactions with LiPS products during discharge. Hence, Pt nanoparticle plays crucial role in adsorbing polysulfide species during discharge process and further converting them into long-chain LiPS and elemental sulfur during charging process. As a proof of concept, the feasibility of extending this concept to non-noble metal catalyst, similar experiments have been conducted by taking bulk WC and TiC as electrodes against PS based electrolyte.

Electrocatalysis principles into Li—S battery configuration to stabilize polysulfide shuttle process and to enhance the rate capabilities. Pt/Graphene and Ni/Graphene has exhibited reduced overpotential and excellent specific capacity over pristine graphene electrodes. More importantly, presence of electrocatalyst (Pt) helps to demonstrate 40% enhancement in the specific capacity over pristine graphene with a coulombic efficiency above 99.3%. Postpartum analysis of electrodes further confirms the catalyst affinity towards adsorbing soluble polysulfides and converting them into long-chain polysulfides without allowing them to precipitate much on the electrode. Thus, introducing catalyst in Li—S system will open a new avenue for improving electrochemical performance.

The device may comprise a cathode comprising an electrocatalytically active metal, or mixed metals, or alloys with carbon/sulfur composite or carbon itself. The carbon structure may be carbon nanotubes (CNT), graphene, mesoporous or microporous carbon, bio-waste derived carbon, activated carbon, carbon fibers, or any other carbon composition for Metal-Sulfur or Metal-Polysulfide battery configurations. Examples include but are not limited to a metal which may be Ni, Pt, Pd, Co, Fe, Cr, Ti, Mn, Zn Cu, Pb, Cd, Mo, In, Sn, W, Bi, Rh, Ag, Nb, Zr, etc; mixed metals and alloys comprising any of these electrochemically active metals.

The device may comprise electrocatalytically active Metal oxides or Mixed Metal oxides with general formula MxOy or M1xM2xOy x=0-3 and Y=0-5 as an itself an Electrodes or composite with sulfur as an electrodes for Metal-Polysulfide and Metal-S battery systems. Examples include but are not limited to oxides or mixed oxides any of metals (M) or mixed metals (M1 and M2) like Ni, Pt, Pd, Co, Fe, Cr, Ti, Mn, Zn Cu, Pb, Cd, Mo, In, Sn, W, Bi, Rh, Ag, Nb, Zr, etc.

The device may comprise electrocatalytically active Metal oxides or Mixed Metal oxides (MxOy or M1xM2xOy x=0-3 and Y=0-5) contained carbon composites itself an Electrodes or composite with sulfur as an electrodes for Metal-Polysulfide and Metal-S battery systems. Examples: Oxides or mixed oxides any of metals (M) or mixed metals (M1 and M2) like Ni, Pt, Pd, Co, Fe, Cr, Ti, Mn, Zn Cu, Pb, Cd, Mo, In, Sn, W, Bi, Rh, Ag, Nb, Zr, etc. Carbon may be Carbon Nanotubes (CNT), Graphene, Meso/Mirco porous carbon, bio-waste derived carbon, activated carbon, carbon fibers etc.)

The device may comprise electrocatalytically active Metal sulfides with the general formula MxS, M=1-3 as an itself or composite with carbon as an Electrodes or composite with sulfur as an electrodes for Metal-Polysulfide and Metal-S battery systems. Examples: sulfides of any of metals like Ni, Pt, Pd, Co, Fe, Cr, Ti, Mn, Zn Cu, Pb, Cd, Mo, In, Sn, W, Bi, Rh, Ag, Nb, Zr, etc. Carbon may be Carbon Nanotubes (CNT), Graphene, Meso/Mirco porous carbon, bio-waste derived carbon, activated carbon, carbon fibres etc.)

### EXAMPLES

### Example 1: Preparation of Different Polysulfides

Polysulfide solutions were prepared by heating substantially stoichiometric amounts of Li₂S and S to obtain Li₂S₈ in tetraethylene glycol dimethyl ether (TEGDME) at 90° C. with effective stirring for about 12 hours. Such prepared polysulfides used directly as active material along with an electrolyte consisting of 1M lithium bis (trifluoromethanesulfonyl) imide (LiTFSI) and 0.1M lithium nitrate (LiNO3) in TEGDME. The polysulfide concentrations used here as 60, 100, 200 and 600 mM and these are calculated based on the sulfur content in the polysulfide solutions.

### Example 2: Preparation of Different Electrocatalytic Electrodes

Ni, Pt, Au and Al metal thin films were deposited using e-beam evaporator on Al foil and SS foil substrates individually with the film thickness of 50 nm (50 & 200 nm for Ni films) to use them as electrode materials towards lithium polysulfide conversions. In an e-beam evaporation process, a high intensity electron beam was used to vaporize the desired metal sources, which are placed on sample holder. Upon e-beam focusing, the metal atoms evaporate and condense on the surface of the Al and SS substrate positioned in face of the precursor source material. A thickness monitor placed in front of the substrate allowed for control and monitoring of thickness of the evaporated thin films. Temescal FC/BJD2000 deposition system was used to depositing all thin-films with different thickness at 250° C. under vacuum system with base pressure of 5×10⁻⁶ Torr.

Two types of 3DNi electrodes were used: commercially available 3D Ni foam (MTI Corporation), and one prepared by a galvanostatic electrodeposition method. Firstly, the Ni—Cu alloy films were deposited on a foil having a roughened stainless steel (SS) surface, followed by removal of the Cu component from the alloy. The electrodeposition of Ni—Cu alloy was carried out using three-electrode cell consisting of consisting of 4 ml aqueous solution of NiSO4 (1M), CuSO₄ (0.05 M) and citric acid as an electrolyte, stainless steel foil (Type 304, 0.1 mm thick, Alfa Aesar) as working electrode, Ag/AgCl reference electrode (CH Instruments) and the stainless steel strip as counter electrode. Electrochemical deposition was typically conducted under galvanostatic conditions of −10 mA cm⁻² at room temperature for 2 h. using GAMRY potentiostat/galvanostat.

### Example 3: Cell Fabrication and Characterizations

Coin cells of standard 2032 were constructed to evaluate the electrochemical performance of the different electrocatalysts towards polysulfide conversions or as a cathode for Li-polysulfide batteries. The coin cell fabrication was carried out in an argon-filled glove box using 10 μl Li2S8 polysulfide place on elecrocatalyst, metallic lithium anode and an electrolyte along with celgard separator. Coin cells were tested for cyclic voltammograms (CV) in the potential range 1.5˜3.0 V with different scan rates from 0.2 to 1.0 mV s⁻¹ and impedance (EIS) studies from 100 KHz to 200 mHz using Bio-logic electrochemical work station. Charge-discharge studies for different electrocatalysts at C/10 rate and rate capability test at different current rates (C/10, C/5 and C/2 rate) were carried out in the potential range of 1.5˜3.0 V using ARBIN charge-discharge cycle life tester. The capacity values were calculated using mass of sulfur in polysulfide solution and corresponding current rates are considered based on 1674 mAh g⁻¹ (1 C) equivalent to full discharge or charge in 1 h. The morphology of the samples were characterized by a JSM 401F (JEOL Ltd., Tokyo, Japan) SEM operated at 3.0 kV and a JEM 2010 (JEOL Ltd, Tokyo, Japan). X-ray diffraction (XRD) patterns were recorded on a Bruker D8 Advance diffractometer at 40.0 kV and 120 mA with Cu-Kα radiation.

1. A battery comprising:
a cathode having the formula XₐY_{b}Z_{c}, wherein:
X is a first metal;
Y is a second metal;
Z is selected from the group consisting of O, C, N, and S;
a is an integer between 1 and 3;
b is an integer between 0 and 3; and
c is an integer between 0 and 7.

2. The battery according to claim 1 wherein X and Y are selected from the group consisting of Ni, Pt, Pd, Co, Fe, Cr, Ti, Mn, Zn, Cu, Pb, Cd, Mo, In, Sn, W, Bi, Rh, Ag, Nb, Au, and Zr.

3. The battery of claim 1, wherein X is selected from the group consisting of Ni, Pt, Pd, Co, Fe, Cr, Ti, Mn, Zn, Cu, Pb, Cd, Mo, In, Sn, W, Bi, Rh, Ag, Nb, Au, and Zr, and wherein b=0.

4. The battery of claim 1, wherein Z═O.

5.-7. (canceled)

8. The battery of claim 1, wherein the cathode has a structure selected from macroporous, mesoporous, nanoporous, and microporous.

9. The battery of claim 1, further comprising an anode comprising at least one metal selected from the group consisting of Li, K, Ca, Na, Mg, Al, Mn, and Zn.

10. (canceled)

11. The battery of claim 1, further comprising an electrolyte containing one of a polyselenides compound and a polysulfides compound of the metal of the anode.

12. The battery of claim 1, wherein the cathode is a current collector.

13.-17. (canceled)

18. The battery of claim 1, wherein the cathode comprises an electrocatalytic nanoparticle anchored to a base structure.

19. The battery according to claim 18 wherein the base structure comprises a carbon structure.

20.-29. (canceled)

30. The battery of claim 18, wherein the base structure comprises a nitrogen-doped graphene.

31. The battery of claim 18, wherein the base structure comprises a carbon nanotube.

32. A current collector for a battery having the formula XₐY_{b}Z_{c}, wherein:
X is a first metal;
Y is a second metal;
Z is selected from the group consisting of O, C, N, and S;
a is an integer between 1 and 3;
b is an integer between 0 and 3; and
c is an integer between 0 and 7.

33. The current collector according to claim 32 wherein X and Y are selected from the group consisting of Ni, Pt, Pd, Co, Fe, Cr, Ti, Mn, Zn, Cu, Pb, Cd, Mo, In, Sn, W, Bi, Rh, Ag, Nb, Au, and Zr.

34. The current collector of claim 32, wherein X is selected from the group consisting of Ni, Pt, Pd, Co, Fe, Cr, Ti, Mn, Zn, Cu, Pb, Cd, Mo, In, Sn, W, Bi, Rh, Ag, Nb, Au, and Zr, and wherein b=0.

35.-39. (canceled)

39. The battery of claim 32, further comprising an anode comprising at least one metal selected from the group consisting of Li, K, Ca, Na, Mg, Al, Mn, and Zn.

40. (canceled)

41. The battery of claim 32, further comprising an electrolyte containing one of a polyselenide compound and a polysulfide compound of the metal of the anode.

42. (canceled)

43. The battery of claim 32, wherein the current collector is a cathode of the battery.

44. A battery of the configuration M1/M1Q_{g}/M2, wherein:
M1 is at least one metal selected from the group consisting of: Li, K, Ca, Na, Mg, Al, Mn, and Zn;
Q is at least one of a sulfur and selenium;
g is an integer from 1 to 9;
M2 is selected from the group consisting of Fe, Co, Ni, Pd, Pt, Au, Cr, Ti, Mn, Zn, Cu, Pb, Cd, Mo, In, Sn, W, Bi, Rh, Ag, Nb, Zr, and bulk structures, thin films, microporous structures, nanoporous structures, carbon composites, and alloys thereof.

45. The battery of claim 18, wherein the base structure comprises a metal.
